(19) United States
(12) Patent Application Publication
(10) Pub. No.: US 2025/0278712 A1
(43) Pub. Date: Sep. 4, 2025

(54) SYSTEM AND METHOD FOR PROVIDING BUY NOW, PAY LATER SERVICES TO A GROUP OF CONSUMERS

(71) Applicant: Mastercard International Incorporated, Purchase, NY (US)

(72) Inventors: Semal Gajera, Vadodara (IN); Manali Pawar, Pune (IN); Mandar Shenai, Pune (IN); Monica Jain, Pune (IN); Raksha Thakre, Pune (IN); Sumit Dubey, Maryland Heights, MO (US)

(73) Assignee: Mastercard International Incorporated, Purchase, NY (US)

(21) Appl. No.: 18/595,019

(22) Filed: Mar. 4, 2024

(51) Int. Cl. G06Q 20/24; G06Q 20/34

(52) U.S. Cl. CPC G06Q 20/24; G06Q 20/351

(57) ABSTRACT

Techniques are provided for allowing two or more consumers to make a buy now, pay later (BNPL) transaction. A method includes presenting a user interface on a point-of-sale terminal. The method includes receiving a transaction amount, personal information, and financial account details associated with two or more consumers. The personal information is transmitted to a credit service computer, which returns a respective credit score for each of the consumers. A determination to issue a BNPL loan is made based on the transaction amount and the respective credit scores. The method includes transmitting a request for a single use virtual payment card to a payment network. The payment network returns the single use virtual payment card. The single use virtual payment card is then transmitted to the point-of-sale terminal. The point-of-sale terminal transmits a payment authorization request message that includes the single use virtual payment card and the transaction amount.

### BACKGROUND

The present invention relates generally to installment loans and, more particularly, to Buy Now, Pay Later installment loans offered at a point-of-sale terminal to a group of consumers.

Buy Now, Pay Later (BNPL) loans have gained significant popularity in recent years as an alternative payment method for consumers. The concept behind BNPL is relatively simple: it allows customers to make a purchase and defer the payment over a specified period, typically in multiple installments. Instead of paying the full price upfront, consumers can split their payments into more manageable chunks, often with little to no interest if the installments are paid on time.

BNPL services are typically offered by fintech companies or financial institutions and are integrated into various retail websites, mobile apps, and point-of-sale systems. These services have disrupted traditional credit card usage and provided consumers with greater flexibility and transparency in managing their finances. However, BNPL services are offered to a single consumer during a purchase transaction. In instances where an individual consumer may not be eligible for a BNPL loan amount large enough to cover certain large or “big ticket” purchases, the individual consumer may wish to include a second consumer on the BNPL services request. There is no way, however, for a BNPL lender to offer a split installment BNPL loan and/or check the collective credit eligibility of a group of consumers.

### BRIEF DESCRIPTION

This brief description is provided to introduce a selection of concepts in a simplified form that are further described in the detailed description below. This brief description is not intended to identify key features or essential features of the claimed subject matter, nor is it intended to be used to limit the scope of the claimed subject matter. Other aspects and advantages of the present disclosure will be apparent from the following detailed description of the embodiments and the accompanying figures.

In one aspect, a system allowing two or more consumers to cooperatively make a buy now, pay later (BNPL) transaction is provided. The system includes a processor and a memory device. The memory device has computer-executable instructions stored thereon. The computer-executable instructions cause the processor to present a user interface (UI) on a point-of-sale terminal. The processor receives, via the UI, a transaction amount for the BNPL transaction and respective personal information and financial account details associated with two or more consumers. The processor transmits, to a credit service computer, the personal information of the two or more consumers. The processor receives, from the credit service computer, a respective credit score for each of the two or more consumers. Based on the transaction amount and the respective credit scores, the processor determines to issue a BNPL loan for the transaction amount. Furthermore, the processor transmits, to a payment network, a request for a single use virtual payment card, the single use virtual payment card to be associated with the BNPL loan. In addition, the processor receives, from the payment network, the single use virtual payment card and transmits the single use virtual payment card to the point-of-sale terminal. Moreover, the processor receives a payment authorization request message from the point-of-sale terminal. The payment authorization request message includes the single use virtual payment card and the transaction amount.

In another aspect, a computer-implemented allowing two or more consumers to cooperatively make a buy now, pay later (BNPL) transaction is provided. The method includes presenting a user interface (UI) on a point-of-sale terminal. In addition, the method includes receiving, via the UI, a transaction amount for the BNPL transaction and respective personal information and financial account details associated with two or more consumers. The method includes transmitting, to a credit service computer, the personal information of the two or more consumers. Furthermore, the method includes receiving, from the credit service computer, a respective credit score for each of the two or more consumers. Based on the transaction amount and the respective credit scores, the method includes determining to issue a BNPL loan for the transaction amount. Furthermore, the method includes transmitting, to a payment network, a request for a single use virtual payment card. The single use virtual payment card is to be associated with the BNPL loan. Additionally, the method includes receiving, from the payment network, the single use virtual payment card and transmitting the single use virtual payment card to the point-of-sale terminal. Furthermore, the method includes receiving a payment authorization request message from the point-of-sale terminal. The payment authorization request message includes the single use virtual payment card and the transaction amount.

A variety of additional aspects will be set forth in the detailed description that follows. These aspects can relate to individual features and to combinations of features. Advantages of these and other aspects will become more apparent to those skilled in the art from the following description of the exemplary embodiments which have been shown and described by way of illustration. As will be realized, the present aspects described herein may be capable of other and different aspects, and their details are capable of modification in various respects. Accordingly, the figures and description are to be regarded as illustrative in nature and not as restrictive.

### BRIEF DESCRIPTION OF THE DRAWINGS

The figures described below depict various aspects of systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 is a block diagram of an exemplary system for providing Buy Now, Pay Later (BNPL) financing (e.g., a BNPL loan) for a purchase transaction that may split between two or more consumers, in accordance with an aspect of the present invention;

FIG. 2 is an example configuration of a user computing system, such as the user computing device operated by a consumer shown in FIG. 1;

FIG. 3 is an example configuration of a server system for use with the system shown in FIG. 1; and

FIGS. 4a and 4b depict a flowchart illustrating an exemplary computer-implemented method for allowing two or more consumers to cooperatively make a Buy Now, Pay Later (BNPL) based transaction, based on a collective credit score of the two or more consumers and using a single use virtual payment card (or credential), according to one aspect of the present invention.

Unless otherwise indicated, the figures provided herein are meant to illustrate features of embodiments of this disclosure. These features are believed to be applicable in a wide variety of systems comprising one or more embodiments of this disclosure. As such, the figures are not meant to include all conventional features known by those of ordinary skill in the art to be required for the practice of the embodiments disclosed herein.

### DETAILED DESCRIPTION

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized, and changes may be made without departing from the scope of the claims. The following description is, therefore, not limiting. The scope of the present invention is defined only by the appended claims, along with the full scope of equivalents to which such claims are entitled.

As used herein, the term “database” includes either a body of data, a relational database management system (RDBMS), or both. As used herein, a database includes, for example, and without limitation, a collection of data including hierarchical databases, relational databases, flat file databases, object-relational databases, object-oriented databases, and any other structured collection of records or data that is stored in a computer system. Examples of RDBMS's include, for example, and without limitation, Oracle® Database (Oracle is a registered trademark of Oracle Corporation, Redwood Shores, Calif.), MySQL, IBM® DB2 (IBM is a registered trademark of International Business Machines Corporation, Armonk, N.Y.), Microsoft® SQL Server (Microsoft is a registered trademark of Microsoft Corporation, Redmond, Wash.), Sybase® (Sybase is a registered trademark of Sybase, Dublin, Calif.), and PostgreSQL® (PostgreSQL is a registered trademark of PostgreSQL Community Association of Canada, Toronto, Canada). However, any database may be used that enables the systems and methods to operate as described herein.

Broadly, embodiments provide a system and method for facilitating Buy Now, Pay Later (BNPL) loan offers that can be evenly or proportionally split between two or more consumers. Upon request of a BNPL loan by two or more consumers, a BNPL lender may make a determination whether to finance the purchase based on a collective and/or weighted credit score of the two or more consumers.

### Exemplary System

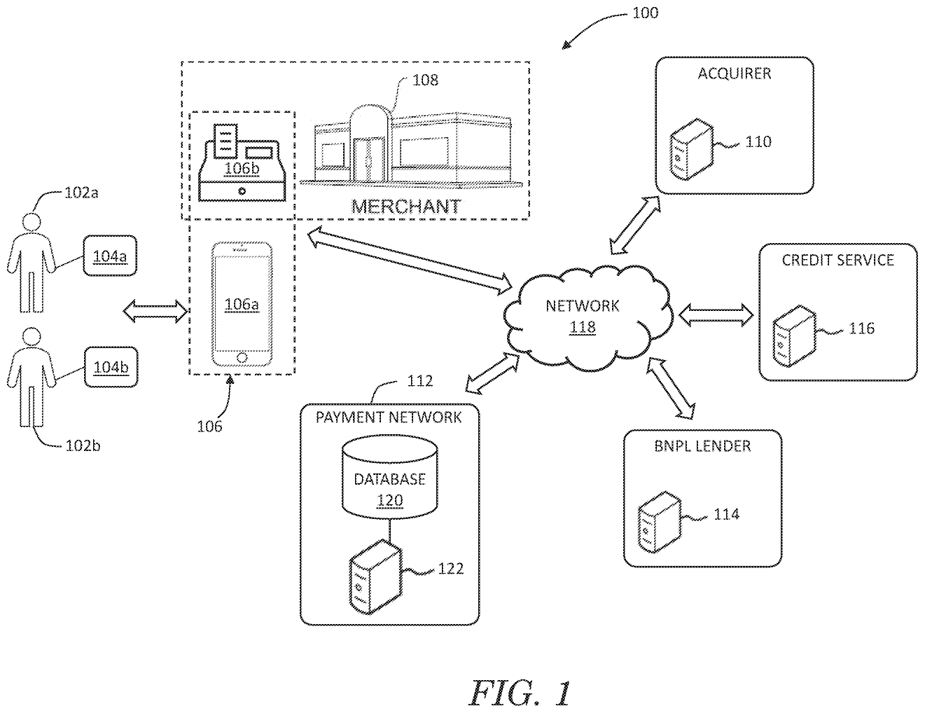

FIG. 1 is a block diagram of an exemplary system 100 for providing Buy Now, Pay Later (BNPL) financing (e.g., a BNPL loan) for a purchase transaction that may split between two or more consumers 102a, 102b, in accordance with an aspect of the present invention. In the example, each of the consumers 102a, 102b may have at least one payment device, such as payment cards 104a, 104b, respectively. The consumers 102a, 102b may have access to a payment terminal 106 through which the consumers 102a, 102b may request BNPL financing for a purchase transaction split between the consumers 102a, 102b. In the example embodiment, the payment terminal 106 may include any processor implemented data processing device, such as a user computer device (e.g., a smartphone) 106a, a point-of-sale (POS) terminal 106b, or any other data processing device. A user computer device 106a may be associated with the consumers 102a, 102b, such that each of the consumers 102a, 102b may be associated with a respective user computer device 106a. The POS terminal 106b may be a data processing device associated with a merchant, such as the merchant 108. In some embodiments, the POS terminal may include a merchant checkout user interface (UI) displayed on a display of the user computer device 106a or other data processing device.

In the example embodiment, the system 100 also generally includes a merchant acquirer computer 110, a payment network 112, a BNPL lender computer 114, and a credit service computer 116. The payment terminal 106, the merchant acquirer computer 110, the payment network 112, the BNPL lender computer 114, and the credit service computer 116 are coupled in communication via a communications network 118. The network 118 includes, for example and without limitation, one or more of a local area network (LAN), a wide area network (WAN) (e.g., the Internet, etc.), a mobile network, a virtual network, and/or any other suitable public and/or private network capable of facilitating communication among the payment terminal 106, the acquirer computer 110, the payment network 112, the BNPL lender computer 114, and/or the credit service computer 116. In some embodiments, the network 118 may include more than one type of network, such as a private payment transaction network provided by the payment network 112 to the acquirer computer 110 and the BNPL lender computer 114 and, separately, the public Internet, which may facilitate communication between the merchant 108, the payment network computer 112, the acquirer computer 110, the BNPL lender computer 114, the credit service computer 116, and the consumers 102a, 102b, etc.

Embodiments described herein may relate to a payment card system, such as a credit card payment system using the Mastercard® interchange network. (Mastercard is a registered trademark of MasterCard International Incorporated). The Mastercard interchange network is a set of proprietary communications standards promulgated by Mastercard International Incorporated for the exchange of financial transaction data and the settlement of funds between financial institutions that are members of Mastercard International Incorporated.

In a typical payment card system, a financial institution called the “issuer” may issue a financial account and associated payment card, such as one of the payment cards 104a, 104b (e.g., a credit card, debit, etc.), to a consumer, such as one of the consumers 102a, 102b. The consumer may use the payment card to tender payment for a purchase from the merchant 108. The merchant 108 typically may be associated with products, such as goods and/or services, that may be offered for sale and may be sold to the consumer. The merchant 108 may include, for example, a physical location and/or a virtual location. A physical location may include, for example, a brick-and-mortar store, etc., and a virtual location may include, for example, an Internet-based store-front.

In an example embodiment, the consumers 102a, 102b may cooperatively use the payment cards 104a, 104b to request a BNPL loan from the BNPL lender (i.e., an issuer) via the BNPL lender computer 114 to tender payment for a large purchase from the merchant 108. The BNPL lender may provide the BNPL loan to the consumers 102a, 102b and issue a financial account and associated single use virtual payment card to the consumers 102a, 102b to tender payment for the large purchase. Through the virtual payment card issued by the BNPL lender computer 114, a group of consumers can supply an amount of payment, which is subsequently spread across multiple payment cards for repayment in installments. The BNPL loan may be repaid to the BNPL lender by the consumers 102a, 102b in installments split amongst the consumers 102a, 102b.

To accept payment with the single use virtual payment card, the merchant 108 must normally establish an account with a financial institution that is part of the system 100. This financial institution is usually called the “merchant bank,” the “acquiring bank,” or the acquirer computer 110. When the consumer(s) present payment for a purchase with, for example, the single use virtual payment card issued by the BNPL lender computer 114, the merchant 108 may request authorization from the acquirer computer 110 for the amount of the purchase. Typically, the request is performed using the POS terminal 106b. The POS terminal 106b may communicate electronically with one or more transaction processing computers of the acquirer, such as the acquirer computer 110, to transmit the account information associated with the single use virtual payment card thereto. Alternatively, the acquirer may authorize a third party to perform transaction processing on its behalf. In this case, the POS terminal 106b will be configured to communicate with the third party. Such a third party is usually called a “merchant processor,” an “acquiring processor,” or a “third party processor.” As discussed above, a POS terminal may include a merchant checkout user interface (UI) displayed on the user computer device 106a or other data processing device.

Using the payment network 112, computers of the acquirer 110 or merchant processor may communicate with computers of the BNPL lender 114 to determine whether the single use virtual payment card account is in good standing and whether the purchase is covered by the available credit line. Based on these determinations, the request for authorization may be declined or accepted. If the request is accepted, an authorization code may be issued to the merchant 108.

When a request for authorization is accepted, the available credit line of the single use virtual payment card account may be decreased. After the merchant 108 ships or delivers the goods or services, the merchant 108 may capture the transaction by, for example, appropriate data entry procedures on the POS terminal. This may include bundling of approved transactions daily for standard retail purchases. If the consumer(s) cancels the transaction before it is captured, a “void” may be generated. If the consumer(s) returns the goods after the transaction has been captured, a “credit” may be generated. The payment network 112 and/or the BNPL lender computer 114 may store the transaction information, such as, and without limitation, a type of merchant, a merchant identifier, a location where the transaction was completed, an amount of purchase, and a date and time of the transaction, in a database, such as the database 120.

After a purchase has been made, a clearing process may occur to transfer additional transaction data related to the purchase among the parties to the transaction, such as the acquirer computer 110, the payment network 112, and the BNPL lender computer 114. More specifically, during and/or after the clearing process, additional data, such as a time of purchase, a merchant name, a type of merchant, purchase information, user account information, a type of transaction, itinerary information, information regarding the purchased item and/or service, and/or other suitable information, may be associated with a transaction and transmitted between parties to the transaction as transaction data, and may be stored by any of the parties to the transaction.

After a transaction is authorized and cleared, the transaction may be settled among the merchant 108, the acquirer computer 110, and the BNPL lender computer 114. Settlement refers to the transfer of financial data or funds among the merchant 108, the acquirer computer 110, and the BNPL lender computer 114 related to the transaction. Usually, transactions may be captured and accumulated into a “batch,” which may be settled as a group. More specifically, a transaction typically may be settled between the BNPL lender computer 114 and the payment network 112, and then between the payment network 112 and the acquirer computer 110, and then between the acquirer computer 110 and the merchant 108.

Normally, an interchange fee may be paid by the acquirer to the BNPL lender with respect to a particular transaction, including “zero dollar” authorizations. The interchange fee is a fee charged by the payment network 112 (such Mastercard) to the acquirer for processing a payment card transaction. These fees are typically expressed as a percentage of the transaction value, plus a flat fee per transaction. The interchange fee helps to cover the costs associated with processing the transaction, such as fraud prevention and data processing.

In the example, the payment network 112 includes a virtual payment card server 122 configured to receive a request for a single use virtual payment card (or credential) from the BNPL lender computer 114. The single use virtual payment card (or credential) may be backed by multiple funding accounts (e.g., the payment cards 104a, 104b associated with the participating consumers 102a, 102b). In some examples, the BNPL lender computer 114 may additionally transmit details of the multiple funding accounts and installment repayment arrangements associated therewith. The virtual payment card server 122 may generate the single use virtual payment card (or credential) and write the details associated therewith to a record in the database 120. In addition, the virtual payment card server 122 may write the details of the multiple funding accounts and installment repayment arrangements associated therewith to the single use virtual payment card (or credential) record. Accordingly, a query or data request associated with either of the single use virtual payment card (or credential) and/or the multiple funding accounts may return the details of the installment repayment arrangements that correspond to the single use virtual payment card (or credential). After the single use virtual payment card (or credential) and corresponding installment repayment arrangements have been generated, stored, and transmitted to the consumers 102a, 102b, the consumers 102a, 102b may initiate the transaction with the POS terminal 106 using the single use virtual payment card (or credential), as described above.

### Exemplary Computer Systems

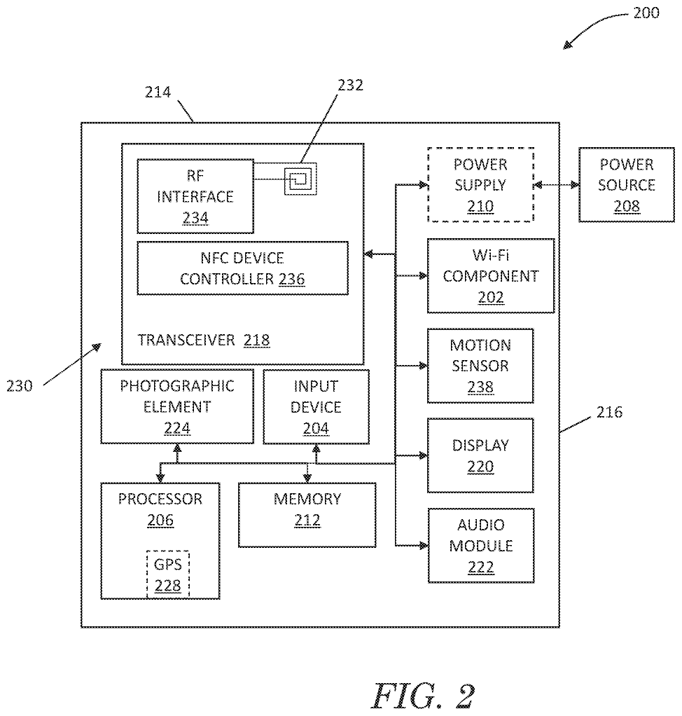

FIG. 2 is an example configuration of a user computing system 200, such as the user computing device 106a (shown in FIG. 1) that may be operated by a user, such as one of the consumers 102a, 102b (shown in FIG. 1). In the exemplary embodiment, the computing system 200 may be a computing device configured to connect wirelessly to one or more of the merchant 108, the BNPL lender 114, the network 1118, and any other computing devices associated with the system 100.

In the exemplary embodiment, the computing system 200 may generally include a processor 206, a memory device 212, a transceiver 218 (or a wireless communication device), and a photographic element 224. In addition, the computing system 200 may include an integrated Wi-Fi component 202 (e.g., implementing the Institute of Electrical and Electronics/IEEE 802.11 family of standards), an input device 204, a display 220, and an audio module 222. Moreover, the computing system 200 optionally may include an internal power supply 210 (e.g., a battery or other self-contained power source) to receive power, or alternatively, in some embodiments, the computing system 200 may include an external power source 208. Optionally, the computing system 200 may include a motion sensor 238.

The processor 206 may include one or more processing units (e.g., in a multi-core configuration) specially programmed for executing computer readable instructions. The instructions may be executed within a variety of different operating systems (OS) on the computing system 200, such as UNIX, LINUX, Microsoft Windows®, etc. More specifically, the instructions may cause various data manipulations on data stored in the memory device 212 (e.g., create, read, write, update, and delete procedures). It should also be appreciated that upon initiation of a computer-based method, various instructions may be executed during initialization. Some operations may be required to perform one or more processes described herein, while other operations may be more general and/or specific to a programming language (e.g., C, C#, C++, Java, or other suitable programming languages, etc.). The memory device 212 may be any device allowing information such as payment card data, the executable instructions, and/or other data to be stored and retrieved. The memory device 212 may include one or more computer readable media.

In the example embodiment, the processor 206 may be implemented as one or more cryptographic processors. A cryptographic processor may include, for example, dedicated circuitry and hardware such as one or more cryptographic arithmetic logic units (not shown) that are optimized to perform computationally intensive cryptographic functions. A cryptographic processor may be a dedicated microprocessor for carrying out cryptographic operations, embedded in a packaging with multiple physical security measures, which facilitate providing a degree of tamper resistance. A cryptographic processor facilitates providing a tamper-proof boot and/or operating environment, and persistent and volatile storage encryption to facilitate secure, encrypted transactions.

Because the computing system 200 may be widely deployed, it may be impractical to manually update software for each computing system 200. Therefore, the system 100 may provide a mechanism for automatically updating the software on the computing system 200. For example, an updating mechanism may be used to automatically update any number of components and their drivers, both network and non-network components, including system level (OS) software components. In some embodiments, the components of the computing system 200 may be dynamically loadable and unloadable; thus, they may be replaced in operation without having to reboot the OS.

A location of the computing system 200 may be obtained through conventional methods, such as a location service (e.g., global positioning system (GPS) service) in the computing system 200, “ping” data that includes geotemporal data, from cell location register information held by a telecommunications provider to which the computing system 200 may be connected, and the like. For example, in one suitable embodiment, an optional GPS chip 228 may be part of or separate from the processor 206 to enable the location of the computing system 200 to be determined.

The Wi-Fi component 202 (broadly, a communication interface) may be communicatively connectable to a remote device such as the POS terminal 106b and the network 118. The Wi-Fi component 202 may include, for example, a wireless or wired network adapter or a wireless data transceiver for use with Wi-Fi (e.g., implementing the Institute of Electrical and Electronics/IEEE 802.11 family of standards), Bluetooth communication, radio frequency (RF) communication, near field communication (NFC), and/or with a mobile phone network, Global System for Mobile communications (GSM), 3G, or other mobile data network, and/or Worldwide Interoperability for Microwave Access (WiMax) and the like.

Stored in the memory device 212 may be, for example, computer readable instructions for providing a user interface to the user, such as a consumer 102a, 102b, via the display 220 and, optionally, receiving and processing input from the input device 204. A user interface may include, among other possibilities, a web browser, a client application, a digital wallet, and the like. Web browsers may enable users, such as the consumers 102a, 102b, to view and interact with media and other information typically embedded on a web page or a website. A client application may allow the consumers 102a, 102b, to interact with a server application, for example, associated with BNPL lender computer 114. A digital wallet may allow the consumers 102a, 102b, to receive, generate, and/or store payment credentials, such as tokens associated with the payment cards 104a, 104b and/or the single use virtual payment card (or credential).

The photographic element 224 may include a camera or other optical sensor and lens combination capable of generating a video signal and capturing an image, iris scan, and the like. In various embodiments, the photographic element 224 may be integrated in a housing or body, such as a housing 214, of the computing system 200. When the photographic element 224 captures an image or otherwise generates image data (e.g., video data), the photographic element 224 may store the image data in a data file, either in a raw or compressed format, in the memory device 212.

In some embodiments, the motion sensor 238 may include one or more sensor elements that facilitate detecting a person's presence. For example, the motion sensor 238 may detect when the consumer 102a, 102b, moves or raises the user consumer system 200. Upon detection of such motion, the photographic element 224 may begin capturing images (e.g., still or video images), the transceiver 218 may be activated, and/or the audio module 222 may begin capturing audio. The motion sensor 238 may be operatively coupled to the photographic element 224 such that the consumer's presence may be detected by detecting motion using the photographic element 224. The motion sensor 238 may include, for example, and without limitation, sensor elements such as a passive infrared sensor, an ambient light sensor, and the like.

In the example embodiment, the display 220 may include, for example, and without limitation, a liquid crystal display (LCD), an organic light emitting diode (OLED) display, or an “electronic ink” display. In some embodiments, a single component such as a touch screen may function as both an output device (e.g., the display 220) and the input device 204. As such, the display 220 may optionally include a touch controller for support of touch capability. In such embodiments, the computing system 200 may detect the presence of the consumer 102a, 102b, by detecting that the consumer 102a, 102b, has touched the display 220 of the computing system 200.

The audio module 222 may include, for example, and without limitation, a speaker and related components capable of broadcasting streaming and/or recorded audio and may also include a microphone. The microphone facilitates capturing audio through the computing system 200.

In the example embodiment, the computing system 200 includes the housing 214 at least partly (and more preferably, at least substantially or entirely) enclosing the components described above. In addition, the computing system 200 includes circuitry 230 configured to communicate with the network 118 (shown in FIG. 1) and/or other computing devices (e.g., other mobile devices, the computers or systems 106b, 110, 112, 114, 116, and 122, etc.). The circuitry 230 may include, for example, leads, connectors, NFC-enabled circuitry, Wi-Fi-enabled circuitry, and photographic element circuitry. The housing 214 is preferably configured to seal the circuitry 230, which is susceptible to degradation from the ambient environment. In one embodiment, the circuitry 230 is hermetically sealed in the housing 214. For example, in one embodiment, the circuitry 230 is completely and permanently encased within the housing 214. In other words, the housing 214 and the circuitry 230 are intended to remain as a single, inseparable unit throughout the life of the computing system 200. It is understood that the housing 214 can be formed separately from the circuitry 230 and that the circuitry 230 can be placed into and sealed within the housing 214 in a separate operation. It is also understood that the housing 214 can be oversized with respect to the circuitry 230 so that the circuitry 230 can be placed loosely into the housing 214. In another embodiment, the circuitry 230 can be selectively, sealingly enclosed within the housing 214, where the housing 214 includes a closure 216 removably attached to a body of the housing 214.

The housing 214 may be fabricated from a suitably selected material that facilitates inhibiting the effect the material has on the signal being emitted from, for example, the transceiver 218 and/or the Wi-Fi component 202 and passing through the housing material. For example, and without limitation, suitable materials from which the housing 214 may be fabricated include polyethylene, propylene, isoprene, and butylenes (i.e., polyolefins). In other embodiments, the housing 214 may be fabricated from any material that enables the computing system 200 to function as described herein, such as metals, etc.

In one embodiment, the transceiver 218 may include an antenna 232. The antenna 232 includes a looped wire configured to transmit radio signals when current flows through the looped wire. The antenna 232 is any size, shape, and configuration that is suitable for transmitting signals as described herein. For example, the antenna 232 may be a tuned circuit configured to transmit radio signals in any radio-based communication system including, but not limited to, Radio Frequency Identification (RFID), Wireless Local Area Network (WLAN), and Wireless Personal Area Network (WPAN) systems. In the example embodiment, the antenna 232 generates a magnetic field when it vibrates at a selected frequency. Specifically, the antenna 232 may be configured to vibrate at a frequency of about 13.56 MHz, which is suitable for use in a near field communication (NFC) system.

In the example embodiment, the antenna 232 may transmit radio signals to and may receive radio signals from other wireless-enabled computing devices, for example, another mobile device, the computers or systems 106b, 110, 112, 114, 116, and 122, and/or any other components used in wireless systems. In NFC systems, for example, at least one NFC component generates a magnetic field to inductively transfer currents and, thereby, exchange signals and information with other NFC components positioned within the magnetic field. In one example embodiment, the antenna 232 may function as an NFC component to send and receive signals. The antenna 232 may be configured to transmit radio signals to NFC components positioned within the magnetic field of the antenna 232, such as when the computing system 200 is positioned within a predetermined distance of the POS terminal 106b. Therefore, the magnetic field generated by the antenna 232 may define the active range of the computing system 200. Additionally, the antenna 232 may receive radio signals from NFC components when the antenna 232 is positioned within the magnetic field of the NFC components.

The transceiver 218 also may include a radio frequency (RF) interface 234 and an NFC device controller 236. The RF interface 234 and the NFC device controller 236 may be powered by the power source 208, and in some embodiments, the internal power supply 210 and/or the display 220. In addition, the processor 206 and the memory device 212 may be powered in the same manner. The RF interface 234 may be configured to receive and transmit RF signals through the antenna 232. The NFC device controller 236 may be configured to process the received RF signals and to generate signals to be transmitted by the RF interface 234. The memory device 212 may be configured to store data associated with transmitting and receiving the RF signals. The NFC device controller 236 may be coupled in communication with the processor 206.

In some embodiments, the computing system 200 may be connected to one or more peripheral devices (not shown). That is, the computing system 200 may communicate various data with one or more peripheral devices. For example, the computing system 200 may communicate with one or more peripheral devices through the Wi-Fi component 202, the transceiver 218, or other suitable means.

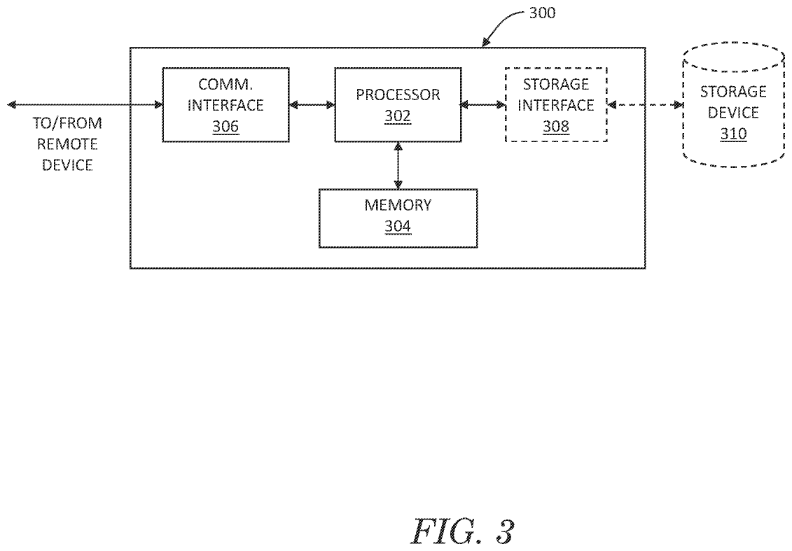

FIG. 3 is an example configuration of a server system 300. In an embodiment, the server system 300 may include, but not be limited to, the POS terminal 106b, the acquirer computer 110, the BNPL lender computer 114, the credit service computer 116, and/or the virtual payment card server 122 (all shown in FIG. 1). In the example embodiment, the server system 300 may include a processor 302 for executing instructions. The instructions may be stored in a memory 304, for example. The processor 302 may include one or more processing units (e.g., in a multi-core configuration) for executing the instructions. The instructions may be executed within a variety of different operating systems on the server system 300, such as UNIX, LINUX, Microsoft Windows®, etc. More specifically, the instructions may cause various data manipulations on data stored in a storage device 310 (e.g., create, read, update, and delete procedures). It should also be appreciated that upon initiation of a computer-based method, various instructions may be executed during initialization. Some operations may be required to perform one or more processes described herein, while other operations may be more general and/or specific to a programming language (e.g., C, C#, C++, Java, or other suitable programming languages, etc.).

The processor 302 may be operatively coupled to a communication interface 306 such that the server system 300 can communicate with a remote device such as a user computing system 200 (shown in FIG. 2), one or more of the computers or systems 106b, 110, 112, 114, 116, and 122, and/or another server system. For example, the communication interface 306 may receive communications from a user computing device 106a via the Internet (FIG. 1).

The processor 302 may be operatively coupled to the storage device 310. The storage device 310 may be any computer-operated hardware suitable for storing and/or retrieving data. In some embodiments, the storage device 310 may be integrated in the server system 300. In other embodiments, the storage device 310 may be external to the server system 300. The storage device may be similar to the 120 (shown in FIG. 1). For example, the server system 300 may include one or more hard disk drives as the storage device 310. In other embodiments, the storage device 310 may be external to the server system 300 and may be accessed by a plurality of server systems 300. For example, the storage device 310 may include multiple storage units such as hard disks or solid-state disks in a redundant array of inexpensive disks (RAID) configuration. The storage device 310 may include a storage area network (SAN) and/or a network attached storage (NAS) system.

In some embodiments, the processor 302 may be operatively coupled to the storage device 310 via a storage interface 308. The storage interface 308 may be any component capable of providing the processor 302 with access to the storage device 310. The storage interface 308 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 302 with access to the storage device 310.

The memory 304 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only and are thus not limiting as to the types of memory usable for storage of a computer program.

### Computer-Implemented Methods

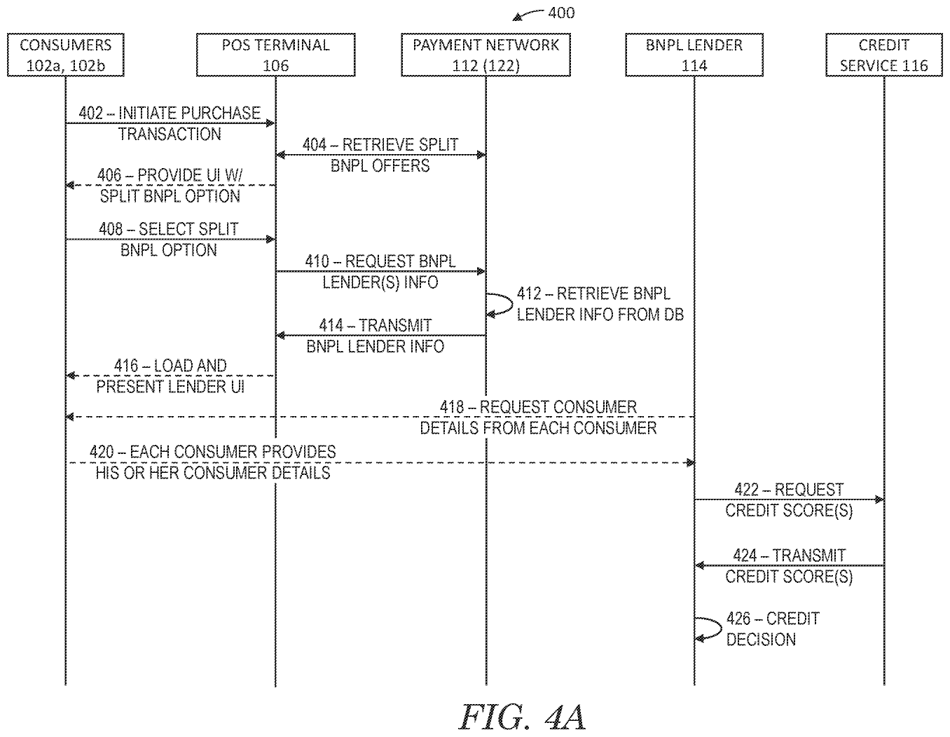

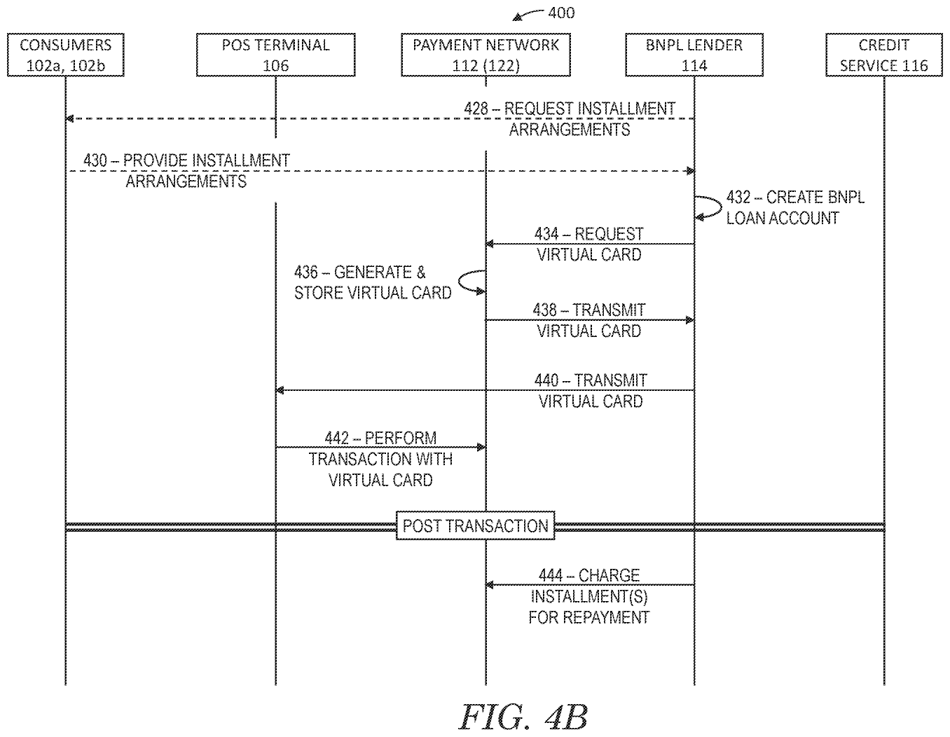

FIGS. 4a and 4b depict a flowchart illustrating an exemplary computer-implemented method 400 for allowing two or more consumers to cooperatively make a Buy Now, Pay Later (BNPL) based transaction, based on a collective credit score of the two or more consumers and using a single use virtual payment card (or credential), according to one aspect of the present invention. The operations described herein may be performed in the order shown in FIGS. 4a and 4b or, according to certain inventive aspects, may be performed in a different order. Furthermore, some operations may be performed concurrently as opposed to sequentially, and/or some operations may be optional, unless expressly stated otherwise or as may be readily understood by one of ordinary skill in the art.

The computer-implemented method 400 is described below, for ease of reference, as being executed by exemplary devices and components introduced with the embodiments illustrated in FIGS. 1-3. In one embodiment, the computer-implemented method 400 is implemented by the BNPL lender computer 114 (shown in FIG. 1). While operations within the computer-implemented method 400 are described below regarding the BNPL lender computer 114, according to some aspects of the present invention, the computer-implemented method 400 may be implemented using any other computing devices and/or systems of the system 100 through the utilization of processors, transceivers, hardware, software, firmware, or combinations thereof. A person having ordinary skill will also appreciate that responsibility for all or some of such actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the steps outlined herein. The program(s) stored on the computer-readable medium(s) may instruct the processor or processing units to perform additional, fewer, or alternative actions, including those discussed elsewhere herein.

In the exemplary embodiment, at step 402 the consumers 102a, 102b may initiate a purchase transaction, for example, at the merchant 108 via the POS terminal 106. As described herein, the merchant 108 may include a physical location and/or a virtual location. Accordingly, in an embodiment, the purchase transaction may be initiated at the POS terminal 106b, for example, if the transaction is being performed at a merchant's physical location, such as a brick-and-mortar store, etc. If the transaction is being performed online, for example, at a merchant's virtual location, the transaction may be initiated at the user computer device 106a. It is understood, however, that the transaction may be initiated at any computing device and/or merchant location configured to perform a purchase transaction on behalf of the merchant, such as the merchant 108.

At step 404, the POS terminal 106 may retrieve one or more Buy Now, Pay Later (BNPL) offers from the payment network 112, including a split installment BNPL offer. For example, the merchant 108 generally must integrate with the payment network 112 in order to retrieve and provide BNPL offers to its customers, such as consumers 102a, 102b. This integration typically involves setting up a connection between the POS system 106 and the payment network's API (Application Programming Interface). In the exemplary embodiment, the payment network 112 also operates as a BNPL provider interface, wherein various BNPL providers or lenders offering BNPL services provide various offers to the payment network 112 for distribution to various merchants, such as the merchant 108.

At step 406, the POS terminal 106 may present a selection of payment options and may prompt the consumer to choose one of the payment options. In addition to traditional payment methods (e.g., cash, debit card, credit card, etc.), the one or more BNPL offers, including the split installment BNPL offer, are presented as alternatives. The selection of payments options may be presented to the consumers via a merchant checkout user interface (UI) displayed on a display of the user computer device 106a, POS terminal 106b, or other data processing device being used to perform the transaction. In some embodiments, the BNPL offer may include a visual and/or an audio machine-readable code. For example, the one or more BNPL offers may include, without limitation, a one-dimensional (1D) barcode or a two-dimensional (2D) barcode (e.g., a matrix barcode). A 1D barcode uses a series of variable-width lines and spaces to encode data. A 2D barcode uses patterns of squares, hexagons, dots, and other shapes to encode data. A 2D barcode may include, for example, and without limitation, a QR code or other codes such as a Data Matrix code, a PDF417 code, an EZcode, a high capacity color barcode, a ShotCode, a MaxiCode, and the like.

At step 408, the consumers 102a, 102b may select the split installment BNPL offer. For example, when the customers are ready to make a purchase at the POS terminal 106, the POS terminal 106 may prompt the consumers to choose a payment option from the various presented payment options. In one embodiment, the user computer device 106a may be used to interact with the machine-readable code feature presented to the consumers in association with the split installment BNPL offer. For example, the machine-readable code may be captured with a camera, a microphone, radio receiver, or other capture capability provided by the user computer device 106a.

At step 410, The POS terminal 106 may transmit a request signal to the payment network 112 to request information concerning the BNPL lender 114 associated with the split installment BNPL offer selected by the consumers 102a, 102b. At step 412, the payment network 112 may retrieve the BNPL lender information from a database storing various BNPL lender information and associated BNPL offers. For example, in an embodiment, the payment network 112 may retrieve the split installment BNPL lender information from the database 120. The BNPL lender information may include, for example, a BNPL lender webpage and/or BNPL lender API that facilitates the POS terminal 106 presenting a BNPL lender UI to the consumers. At step 414, the payment network 112 may transmit the BNPL lender information to the POS terminal 106.

At step 416, the POS terminal 106 may load and present the BNPL lender UI to the consumers 102a, 102b, for example, based on the received BNPL lender information. Via the lender UI, at step 418, the BNPL lender 114 may prompt the consumers 102a, 102b to provide their personal information and financial account details along with the transaction amount for the transaction. At step 420, each of the consumers 102a, 102b may provide his or her personal information, account details, and the transaction amount to the BNPL lender 114 via the lender UI. This consumer information may permit the BNPL lender 114 to decide whether to provide the BNPL loan to the consumers 102a, 102b. In an embodiment, the financial account details provided by each consumer 102a, 102b may include, for example, a bank account number, and/or a credit or debit card number, whereas the personal information may include a name of the consumer, an address of the consumer, consumer contact information (e.g., an email address, telephone number, and the like), and/or a government provided identification number (e.g., a Social Security Number, Aadhaar, etc.).

At step 422, the BNPL lender 114 may call the credit service 116, for example, via a credit service API, to retrieve a credit rating or credit score for each of the consumers 102a, 102b. For example, in an embodiment, the BNPL lender 114 may submit the personal information to the credit service 116. At operation 424, in response to the submission and based on the submitted consumer information, the credit service 116 may transmit one or more credit scores or ratings to the BNPL lender 114, wherein each credit score or rating is associated with a respective consumer identified in the consumer information.

At step 426, the BNPL may determine whether to provide a BNPL loan to the consumers based on the transaction amount and the credit scores or credit ratings received from the credit service 116. For example, and without limitation, the BNPL lender may combine the respective credit scores or credit ratings into a collective credit score for the group of consumers 102a, 102b. The collective credit score may include a plurality of risk assessment factors, wherein said risk assessment factors are each analyzed to derive individual weighted scores using a computer implemented algorithm executed on the BNPL lender computer 114. In an embodiment, the respective credit score or credit ratings of the consumers 102a, 102b may be averaged to determine a collective credit score. Alternatively, based on the extent of credit history of each of the consumers 102a, 102b, the BNPL lender computer 114 may assign a weight to each of the respective credit scores or credit ratings and combine them together to determine a weighted credit score for the consumers. Based on the collective and/or weighted credit score exceeding a threshold value established by the lender, the BNPL lender computer 114 may determine to issue the BNPL loan in the transaction amount to the consumers. If the collective and/or weighted credit score did not exceed the threshold, the BNPL lender 114 may refuse or decline the BNPL loan request.

At step 428, after determining that the consumers 102a, 102b may receive the BNPL loan, the BNPL lender 114 may request installment arrangements from the consumers for repaying the transaction amount and any associated interest amount (based on terms of the BNPL loan). For example, in an embodiment, via the lender UI presented on the POS terminal 106, the BNPL lender may provide input fields associated with installment arrangement requests.

At step 430, the consumers 102a, 102b may provide installment arrangements to the BNPL lender computer 114, for example, via the lender UI. The installment arrangements may include, for example, a funding account of each consumer for repayment. In addition, the installment arrangements can include, for example, that the installment amounts be split equally between all the consumers participating in the transaction, each respective installment payment may be assigned to a respective consumer, and/or any other arrangement determined by the consumers 102a, 102b and/or provided by the BNPL lender 114.

At step 432, the BNPL lender computer 114 may generate a BNPL loan account associated with each of the funding accounts of the consumers 102a, 102b and the installment arrangements. At step 434, the BNPL lender may request a single use virtual payment card from the payment network 112. The single use virtual payment card may be used to perform the transaction, wherein the virtual payment card may be associated with all the consumer added funding accounts. At step 436, the virtual payment card server 122 of the payment network 112 may generate and store the single use virtual payment card. In the example embodiment, the BNPL PAN may be linked to a specific transaction (based on the BNPL loan request, for example) and/or may have a predefined credit limit based on the BNPL loan approval. As described herein, the single use virtual payment card (or credential) may be backed by the funding accounts of the consumers 102a, 102b (e.g., the payment cards 104a, 104b associated with the consumers 102a, 102b). The virtual payment card may be generated by generating, by the virtual payment card server 122, a primary account number (PAN), referred to herein as a “BNPL PAN,” for the single use virtual payment card. The BNPL PAN may identify the network (e.g., the payment network 112) with which to send transaction messages to and the BNPL lender 114 associated with issuing the BNPL loan. The virtual payment card may be tokenized in a similar manner as the payment cards. In some examples, the BNPL lender computer 114 may transmit details of the multiple funding accounts (i.e., the financial account details) and installment repayment arrangements associated therewith to the virtual payment card server 122. The virtual payment card server 122 may write the BNPL PAN and BNPL loan details associated with the single use virtual payment card to a record in the database 120. In addition, the virtual payment card server 122 may write the details of the multiple funding accounts and installment repayment arrangements associated therewith to the single use virtual payment card (or credential) record. Accordingly, a query or data request associated with either of the single use virtual payment card (or credential) and/or the multiple funding accounts may return the details of the installment repayment arrangements that correspond to the single use virtual payment card (or credential).

At step 438, the virtual payment card server 122 may transmit the BNPL PAN and/or corresponding token to the BNPL lender computer 114. The BNPL lender 114 may store the BNPL PAN and/or corresponding token in association with the BNPL loan account. Accordingly, when a transaction is performed using the BNPL PAN and/or corresponding token, the BNPL lender 114 may appropriately identify the associated funding account for the transaction.

At step 440, the BNPL lender computer 114 may transmit the BNPL PAN and/or corresponding token to the POS terminal 106 for performing the transaction. At step 442, the transaction may be completed as if the consumers 102a, 102b used a traditional payment card. For example, the BNPL lender 114 may receive a payment authorization request message (including the BNPL PAN and transaction amount) from the POS terminal (e.g., via the payment network 112) to complete the transaction using the BNPL PAN for the transaction amount. After approval of the transaction by the BNPL lender 114, the merchant 108 may receive immediate payment from the BNPL lender 114 for the full purchase amount.

At step 444, the BNPL lender 114 may manage the repayment process directly with the consumers 102a, 102b. For example, the BNPL lender 114 may automatically deduct the installment amounts from the consumers linked funding accounts (e.g., the payment cards 104a, 104b associated with the consumers 102a, 102b, bank account, etc.) on the scheduled due dates based on the installment arrangements established during approval of the BNPL loan.

### Additional Considerations

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

The detailed description is to be construed as exemplary only and does not describe every possible embodiment because describing every possible embodiment would be impractical. Numerous alternative embodiments may be implemented, using either current technology or technology developed after the filing date of this patent, which would still fall within the scope of the invention.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order recited or illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. The foregoing statements in this paragraph shall apply unless so stated in the description and/or except as will be readily apparent to those skilled in the art from the description.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processor, may be implemented as special purpose or as general purpose. For example, the processor may comprise dedicated circuitry or logic that is permanently configured, such as an application-specific integrated circuit (ASIC), or indefinitely configured, such as a field-programmable gate array (FPGA), to perform certain operations. The processor may also comprise programmable logic or circuitry (e.g., as encompassed within a general-purpose processor or other programmable processor) that is temporarily configured by software to perform certain operations. It will be appreciated that the decision to implement the processor as special purpose, in dedicated and permanently configured circuitry, or as general purpose (e.g., configured by software) may be driven by cost and time considerations.

Accordingly, the term “processor” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processor is temporarily configured (e.g., programmed), each of the processors need not be configured or instantiated at any one instance in time. For example, where the processor comprises a general-purpose processor configured using software, the general-purpose processor may be configured as respective different processors at different times. Software may accordingly configure the processor to constitute a particular hardware configuration at one instance of time and to constitute a different hardware configuration at a different instance of time.

Computer hardware components, such as transceiver elements, memory elements, processors, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processors may be located in a single location (e.g., within a home environment, an office environment or as a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processor and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Although the disclosure has been described with reference to the embodiments illustrated in the attached figures, it is noted that equivalents may be employed, and substitutions made herein, without departing from the scope of the disclosure as recited in the claims.

Having thus described various embodiments of the disclosure, what is claimed as new and desired to be protected by Letters Patent includes the following:

What is claimed is:

1. A system allowing two or more consumers to cooperatively make a buy now, pay later (BNPL) transaction, the system comprising:
a processor; and
a memory device storing computer-executable instructions thereon, the computer-executable instructions causing said processor to:
present a user interface (UI) on a point-of-sale terminal;
receive, via the UI, a transaction amount for the BNPL transaction and respective personal information and financial account details associated with two or more consumers;
transmit, to a credit service computer, the personal information of the two or more consumers;
receive, from the credit service computer, a respective credit score for each of the two or more consumers;
based on the transaction amount and the respective credit scores, determine to issue a BNPL loan for the transaction amount;
transmit, to a payment network, a request for a single use virtual payment card, the single use virtual payment card to be associated with the BNPL loan;
receive, from the payment network, the single use virtual payment card;
transmit the single use virtual payment card to the point-of-sale terminal; and
receive a payment authorization request message from the point-of-sale terminal, the payment authorization request message including the single use virtual payment card and the transaction amount.

2. The system in accordance with claim 1,
said step of receiving, via the UI, the transaction amount for the BNPL transaction and personal information and financial account details associated with two or more consumers comprising prompting the two or more consumers to provide their personal information and financial account details.

3. The system in accordance with claim 2,
wherein the financial account details include one or more of the following: a bank account number, a credit card number, and a debit card number,
wherein the personal information includes one or more of the following: a name of the consumer, an address of the consumer, an email address, a telephone number, and a government provided identification number.

4. The system in accordance with claim 1,
said step of determining to issue a BNPL loan for the transaction amount comprising combining the respective credit scores into a collective credit score for the two or more consumers.

5. The system in accordance with claim 4,
said step of combining the respective credit scores into a collective credit score comprising averaging the respective credit scores to determine the collective credit score.

6. The system in accordance with claim 4, wherein the collective credit score includes a plurality of risk assessment factors,
the computer-executable instructions further causing the processor to:
analyze each of the plurality of risk assessment factors; and
derive individual weighted scores by executing a computer implemented algorithm.

7. The system in accordance with claim 1,
the computer-executable instructions further causing the processor to request, via the UI, installment arrangements for repaying the transaction amount and any interest amount associated with the BNPL loan.

8. The system in accordance with claim 7,
the computer-executable instructions further causing the processor to receive, via the UI, the installment arrangements, the installment arrangements including one or more of the following: a funding account of each of the two or more consumers, and an instruction on how the installment amounts are split between the two or more consumers.

9. The system in accordance with claim 8,
said step of transmitting the request for a single use virtual payment card comprising transmitting the financial account details and the installment arrangements to a virtual payment card server associated with the payment network.

10. The system in accordance with claim 1,
wherein the single use virtual payment card may be tokenized,
said step of receiving the single use virtual payment card comprising receiving a token corresponding to the single use virtual payment card.

11. A computer-implemented method allowing two or more consumers to cooperatively make a buy now, pay later (BNPL) transaction, the method comprising:
presenting a user interface (UI) on a point-of-sale terminal;
receiving, via the UI, a transaction amount for the BNPL transaction and respective personal information and financial account details associated with two or more consumers;
transmitting, to a credit service computer, the personal information of the two or more consumers;
receiving, from the credit service computer, a respective credit score for each of the two or more consumers;
based on the transaction amount and the respective credit scores, determining to issue a BNPL loan for the transaction amount;
transmitting, to a payment network, a request for a single use virtual payment card, the single use virtual payment card to be associated with the BNPL loan;
receiving, from the payment network, the single use virtual payment card;
transmitting the single use virtual payment card to the point-of-sale terminal; and
receiving a payment authorization request message from the point-of-sale terminal, the payment authorization request message including the single use virtual payment card and the transaction amount.

12. The computer-implemented method in accordance with claim 11,
said step of receiving, via the UI, the transaction amount for the BNPL transaction and personal information and financial account details associated with two or more consumers comprising prompting the two or more consumers to provide their personal information and financial account details.

13. The computer-implemented method in accordance with claim 12,
wherein the financial account details include one or more of the following: a bank account number, a credit card number, and a debit card number,
wherein the personal information includes one or more of the following: a name of the consumer, an address of the consumer, an email address, a telephone number, and a government provided identification number.

14. The computer-implemented method in accordance with claim 11,
said step of determining to issue a BNPL loan for the transaction amount comprising combining the respective credit scores into a collective credit score for the two or more consumers.

15. The computer-implemented method in accordance with claim 14,
said step of combining the respective credit scores into a collective credit score comprising averaging the respective credit scores to determine the collective credit score.

16. The computer-implemented method in accordance with claim 14, wherein the collective credit score includes a plurality of risk assessment factors,
said method further comprising:
analyzing each of the plurality of risk assessment factors; and
deriving individual weighted scores by executing a computer implemented algorithm.

17. The computer-implemented method in accordance with claim 11, further comprising requesting, via the UI, installment arrangements for repaying the transaction amount and any interest amount associated with the BNPL loan.

18. The computer-implemented method in accordance with claim 17, further comprising receiving, via the UI, the installment arrangements, the installment arrangements including one or more of the following: a funding account of each of the two or more consumers, and an instruction on how the installment amounts are split between the two or more consumers.

19. The computer-implemented method in accordance with claim 18,
said step of transmitting the request for a single use virtual payment card comprises transmitting the financial account details and the installment arrangements to a virtual payment card server associated with the payment network.

20. The computer-implemented method in accordance with claim 11,
wherein the single use virtual payment card may be tokenized,
said step of receiving the single use virtual payment card comprising receiving a token corresponding to the single use virtual payment card.
